(19) United States
(12) Patent Application Publication
(10) Pub. No.: US 2008/0195363 A1
(43) Pub. Date: Aug. 14, 2008

(54) Analogue Signal Modelling Routine for a Hardware Description Language

(76) Inventor: Shaun Lytollis, Silverstone (GB)

Correspondence Address: TEXAS INSTRUMENTS INCORPORATED, P O BOX 655474, M/S 3999, DALLAS, TX, 75265, US

(21) Appl. No.: 12/028,448

(22) Filed: Feb. 8, 2008

Related U.S. Application Data
(60) Provisional application No. 61/016,884, filed on Dec. 27, 2007.

(30) Foreign Application Priority Data
Feb. 9, 2007 (GB) 0702576.0

(51) Int. Cl. G06G 7/48

(52) U.S. Cl. 703/3

(57) ABSTRACT

An analogue signal modelling routine for a hardware description language, wherein an output providing an analogue signal is represented by a value stored in an output variable, an input accepting the analogue signal is represented by a value stored in an input variable, and the routine is arranged to update the value stored in the input variable when the value stored on the output value is changed. The level of an analogue signal can be represented using a floating point number.

This application claims priority under 35 U.S.C. 119(a) to GB Provisional Application No. 0702576.0 filed Feb. 9, 2007.

This application claims priority under 35 U.S.C. 119(e)(1) to U.S. Provisional Application No. 61/016,884 (TI-63541P) filed Dec. 27, 2007.

### BACKGROUND OF THE INVENTION

a)Field of the Invention

This invention relates to an analogue signal modelling routine for a hardware description language.

It is common for electronic circuits to be designed and tested using Hardware Description Languages (HDLs). HDLs are computer programming languages that are designed to be particularly suited for giving formal descriptions of electronic circuits; that is, an HDL program can be written that corresponds to a circuit. When an HDL program is executed, the execution simulates the operation of the electronic circuit described, thus allowing the behaviour of the circuit to be studied.

There are many examples of HDLs. Particular HDLs are usually designed primarily for describing either analogue circuits (such as Verilog-AMS and VHDL-AMS, and also SPICE, though this is technically a simulator rather than an HDL) or digital circuits (such as Verilog, AHDL, JHDL). Analogue HDLs have the advantage that there is much more freedom in the types of circuits that can be described.

However a disadvantage of analogue HDLs is that their execution of programs is commonly considerably slower than that of digital HDLs. Another technique is to use an analogue HDL to model the analogue part of a circuit, and a digital HDL to model the digital part, with the two HDLs passing results between each other as they execute their respective programs. (This is known as a mixed-mode HDL.) However the speed of operation of the analogue HDL will often still create a bottleneck for the speed of the overall simulation.

For example, in the SERDES circuit described below, a simulation of the circuit in an analogue HDL would have to be run for a number of weeks to exhibit the range of behaviours necessary for useful testing the circuit. Such a long time frame is undesirable, especially during design of the circuit when a number of changes may be made, and so a number of tests need to be run.

A Verilog program is comprised of a series of modules. Each module represents a functional block of a digital circuit, for example a logic gate (AND, OR, NOT, etc.), a multiplexer or a flip-flop. Modules can refer to other modules that have already been defined, allowing large hierarchical structures to be defined. For example, a module representing a multiplexer might use modules that represent the basic logic gates. Rather than an already-defined module itself being used, a copy or “instance” of the already-defined module is used. This allows a single module, for example one representing an AND gate, to be used a number of times in different places.

Modules use variables called “signals” for their internal and external operation. External signals can be inputs, outputs or “inout”s (combined inputs and outputs) for the module. These connections are known as “ports”. Signals can for example be declared with the keyword “reg”, which means they are a variable which stores a value which can be assigned to at different times. Signals can also for example be declared with the keyword “wire”, which means the signal has no storage of its own and is continuously assigned values stored in other regs. The declaration “wire” alludes to the fact that the signal can be considered as a wire exiting an electronic circuit. Verilog is designed to model digital circuits, and so signals can take binary data only. In particular, a wire can only transmit a single bit of binary data at any one time.

Verliog is also able to use variables of other data types, for example for text and 64-bit floating point numbers. 64-bit floating point numbers are labelled with the type “real”, and are used for time calculations, for example. It would be desirable to be able to use reals to model the levels of analogue signals; for example a value of 1.3 would model a voltage of 1.3V. However, as wires can only take a single bit of binary data, they cannot transmit a value of type real (which contains 64 bits of information). Therefore the real type cannot be used to model analogue signals directly in Verilog.

b) Description of Related Art

A known solution to this problem is to model the levels of analogue signals serially in binary. All modules are written so that a single clock step as used by the circuit modelled by the module in fact consists of a number of smaller clock steps; the binary serialised version of the analogue signal can then be sent down a wire in a “single” clock step (in fact taking a number of clock steps), allowing the analogue signal to be passed between modules. However this solution is inefficient, and makes the simulation of a circuit very slow. Also, the length of a clock step for the overall circuit is fixed by the value used to transmit the analogue signal. This means that modules for circuits that operate faster than the fixed clock step length cannot be added, as analogue values cannot be passed to them sufficiently quickly for their operation.

Another known solution is to model the levels of analogue signals by the length of pulses. For example, a pulse of length 1.3 seconds would model a voltage of 1.3V. Again, however, this requires a single clock step as used by the circuit modelled by the module to consist of a number of smaller clock steps, so that the analogue signal can be transmitted in a “single” clock step, again fixing the length of a time step with the above-mentioned disadvantages.

Another known solution is to use global variables to store the analogue signals as 64-bit floating point numbers. A first module will store its “output” in a certain global variable, and a module using that as “input” reads the value from the global variable. This solution is very fast, and prevents the need for clock steps to be divided. However, this prevents module code from being portable, as it is necessary to know where in the hierarchy modules are in order to access the correct global variables, and modules cannot be reused easily as new global variables are not created for each particular instance of a module, so any instance of a module will store its output in the same global variable. Also, as the analogue signals do not use wires, the resulting program cannot be used to check for wiring errors.

### SUMMARY OF THE INVENTION

According to the present invention there is provided an analogue signal modelling routine for a hardware description language, wherein an output providing an analogue signal is represented by a value stored in an output variable, an input accepting the analogue signal is represented by a value stored in an input variable, and the routine is arranged to update the value stored in the input variable when the value stored on the output value is changed.

Preferably, the input and output variables are arranged to store floating point numbers. Preferable, the floating point numbers comprise 64 bits.

Advantageously, the analogue signal modelling routine comprises an initialisation module arranged to perform the steps of: for each input variable representing an input accepting an analogue signal, determining the corresponding output variable; providing an event routine for updating the value stored in the input variable when the value stored on the output value is changed. Advantageously, each output variable has a corresponding output connection port, and each input variable has a corresponding input connection port. Advantageously, the initialisation module determines the output variable corresponding to an input variable using the corresponding input and output connection ports. Advantageously, the initialisation module is further arranged to perform the step of checking that for each input connection port there exists a corresponding input variable. Preferably, the initialisation module is further arranged to perform the step of checking that the input variable is of a suitable type. Advantageously, the initialisation module is further arranged to perform the step of checking that for each output connection port there exists a corresponding output variable. Preferably, the initialisation module is further arranged to perform the step of checking that the output variable is of a suitable type. Advantageously, a respective event routine is provided for each input variable.

According to the present invention there is further provided a method of modelling an analogue signal in a hardware description language, comprising the steps of: providing an output variable to represent an output analogue signal; providing an input variable to represent an input analogue signal; updating the value stored in the input variable when the value stored on the output value is changed.

Advantageously, the method further comprises the steps of: for each input variable representing an input accepting an analogue signal, determining the corresponding output variable; providing an event routine to perform the step of updating the value stored in the input variable when the value stored on the output value is changed.

Advantageously, the method further comprises the steps of: providing an output connection port corresponding to the output variable; providing an input connection port corresponding to the input variable; wherein the step of determining for an input variable the corresponding output variable is performed using the input connection port.

Advantageously, a respective event routine is provided for each input variable.

According to the present invention there is further provided an analogue signal modelling routine as described above, further comprising a transmission channel modelling routine. Preferably, the transmission channel modelling routine uses an impulse response model.

According to the present invention there is further provided a method of testing a circuit that takes as input an analogue signal, using a hardware description language incorporating an analogue signal modelling routine as described above, comprising the steps of: providing a description of the circuit in the hardware description language; providing an artificial channel characteristic; using the artificial channel characteristic to generate a model of a channel; using the model of the channel to transform an input signal; simulating the behaviour of the circuit when input with the transformed input signal.

The circuit to be tested may comprise a decision feedback equalisation circuit. Advantageously, the method further comprises the steps of: determining the inverse of the artificial channel characteristic; comparing the configuration of the decision feedback equalisation circuit during the simulation of the circuit with the inverse of the artificial channel characteristic. Advantageously, the artificial channel characteristic is chosen to be easily inverted. Advantageously, the artificial channel characteristic is chosen to have a feedback response that drops smoothly with increased frequency.

### BRIEF DESCRIPTION OF THE DRAWINGS

Examples of the invention will now be described with reference to the accompanying drawings, of which:

FIG. 1 is a block diagram a receiver circuit;

FIG. 2 shows the feed forward equaliser and the decision feedback equaliser of the receiver circuit of FIG. 1;

FIG. 3 is a graph showing the post equalised signal amplitude for exemplary bit patterns;

FIG. 4 is a diagram of a transmitter;

FIG. 5a shows the response of the receiver to a PRBS transmitted eye-pattern;

FIG. 5b shows the interleaved output of the ADCs of the receiver;

FIG. 6 is a flow chart of the initialisation procedure for the analogue channel modelling routine according to the present invention;

FIG. 7a is a graph of the frequency response for an example real channel;

FIG. 7b is a graph of the frequency response for an example artificial channel.

### DETAILED DESCRIPTION OF THE PREFERRED EMBODIMENTS

A key challenge facing designers of high-bandwidth systems such as data-routers and super-computers is the requirement to transfer large amounts of data between ICs—either on the same circuit board or between boards. This data transmission application is called Serialisation-Deserialisation or “SerDes” for short. The present invention is useful in SerDes circuit and indeed was developed for that application. Nonetheless the invention may be used in other applications.

Analysis of typical backplane channel attenuation (which is around −24 dB) and package losses (−1 to −2 dB) in the presence of crosstalk predict that an un-equalized transceiver provides inadequate performance and that decision feedback equalization (DFE) is needed to achieve error rates of less than 10-17.

Traditional decision-feedback equalization (DFE) methods for SerDes receivers rely on either modifying, in analogue, the input signal based on the data history [“A 6.25 Gb/s Binary Adaptive DFE with First Post-Cursor tap Cancellation for Serial backplane Communications” R Payne et al ISSCC 2005; “A 6.4 Gb/s CMOS SerDes Core with feed-forward and Decision Feedback Equalization” M. Sorna et al ISSCC 2005; “A 4.8-6.4 Gb/s serial Link for Backplane Applications Using Decision Feedback Equalization” Balan et al IEEE JSSC Nov 2005.] or on having an adaptive analogue slicing level [“Techniques for High-Speed implementation of Non-linear cancellation” S. Kasturia IEEE Journal on selected areas in Communications. June 1991.] (i.e. the signal level at which the circuit decides whether the signal represents a 1 or a 0).

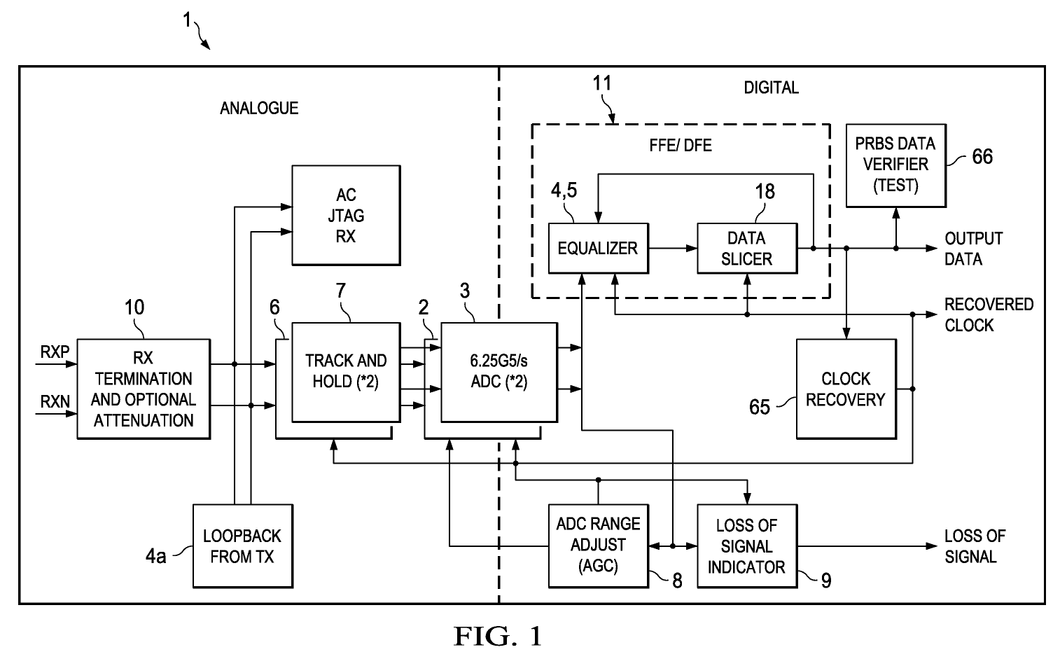

A block diagram of a SerDes receiver circuit 1, which forms part of an integrated circuit, in which the present invention may be used is shown in FIG. 1. The invention may nonetheless be used in other applications.

In the receiver circuit 1 of FIG. 1 the input data is sampled at the baud-rate, digitized and the equalization and clock & data recovery (CDR) performed using numerical digital processing techniques. This approach results in the superior power/area scaling with process of digital circuitry compared to that of analogue, simplifies production testing, allows straightforward integration of a feed-forward equalizer and provides a flexible design with a configurable number of filter taps in the decision feedback equaliser. The circuit has been implemented in 65 nm CMOS, operating at a rate of 12.5 Gb/s.

The receiver circuit 1 comprises two baud-rate sampling ADCs (analogue to digital converters) 2 and 3, a digital 2-tap FFE (feed forward equaliser) 4 and digital 5-tap DFE (decision feedback equaliser) 5 to correct channel impairments.

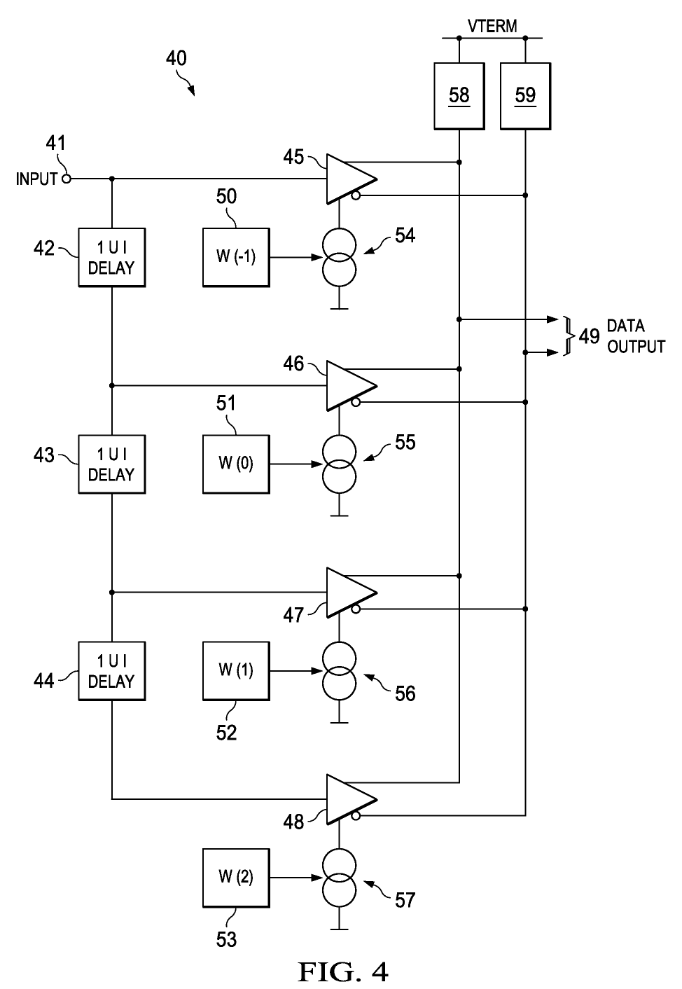

The SerDes section of the integrated circuit, which includes the receiver circuit 1 is also provided with a transmitter 40 (FIG. 4), connected to transmit data over a parallel channel to that which the receiver circuit 1 is connected to receive data. The transmitter 40 comprises a 4-tap FIR filter to pre-compensate for channel impairments. In many applications the integrated circuit transmitting data to the receiver circuit 1 uses pre-compensation and in particular a similar transmitter circuit 40, but in other applications the receiver circuit 1 works without pre-compensation being used at the other end

The receiver 1 of FIG. 1 is now described in more detail. The received data is digitized at the baud-rate, typically 1.0 to 12.5 Gb/s, using a pair of interleaved track and hold stages (T/H) 6 and 7 and a respective pair of 23 level (4.5 bit) full-flash ADCs 2 and 3 (i.e. they sample and convert alternate bits of the received analogue data waveform). The two track & hold circuits enable interleaving of the half-rate ADCs and reduce signal related aperture timing errors. The two ADCs, each running at 6.25 Gb/s for 12.5 Gb/s incoming data rate provide baud-rate quantization of the received data. The ADC's dynamic range is normalized to the full input amplitude using a 7-bit automatic gain control (AGC) circuit 8. A loss of signal indication is provided by loss of signal unit 9 that detects when the gain control signal provided by the AGC is out-of-range. An optional attenuator is included in the termination block 10, which receives the signals from the transmission channel, to enable reception of large signals whilst minimizing signal overload.

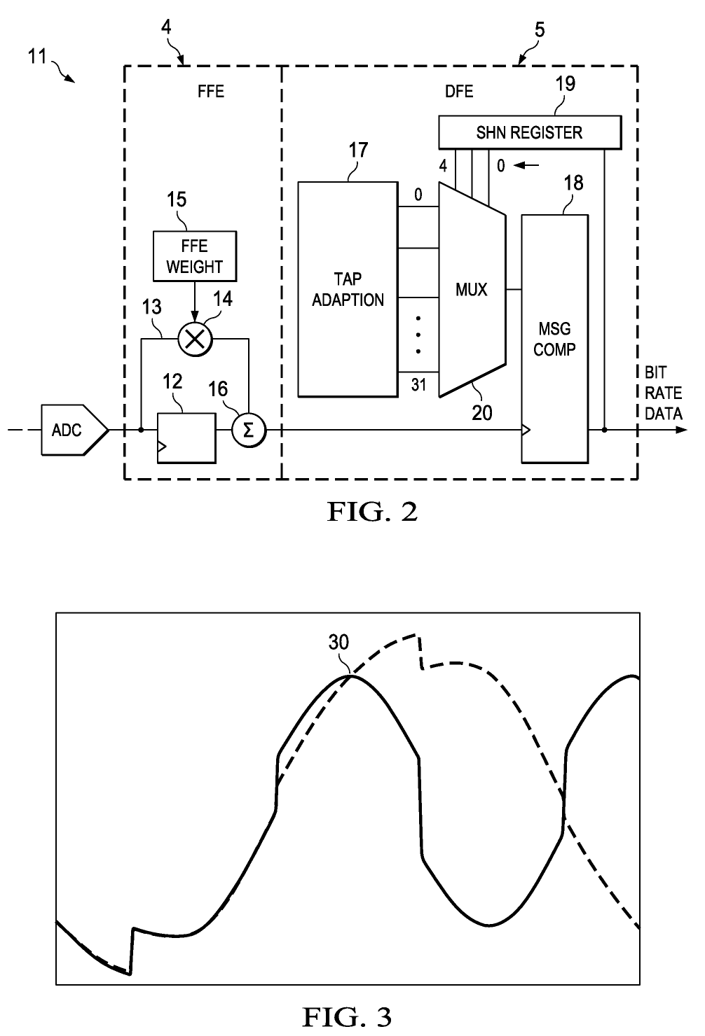

The digital samples output from the ADCs 2 and 3 are interleaved and the resulting stream of samples is fed into a custom digital signal processing (DSP) data-path that performs the numerical feed-forward equalization and decision-feedback equalization. This is shown in FIG. 2. This comprises a 1 UI delay register 12 connected to receive the stream of samples from the ADCs 2 and 3. (1 UI is a period of the clock, i.e. the delay between bits.) A tap 13 also feeds the samples from the ADCs to a multiplier 14, each sample being received by the delay latch 12 and the multiplier 14 at the same time. The multiplier 14 multiplies each sample by a constant weight value (held in a programmable register 15), which value is typically 10%. The outputs of the multiplier 14 and the delay register 12 are added together by an adder 16 to provide the output of the FFE 4.

The digital FFE/DFE is implemented using standard 65 nm library gates.

An advantage of applying the equalization digitally is that it is straightforward to include feed-forward equalization as a delay-and-add function without any noise-sensitive analogue delay elements. The FFE tap weight is selected before use to compensate for pre-cursor ISI and can be bypassed to reduce latency. Whilst many standards require pre-cursor de-emphasis at the transmitter, inclusion at the receiver allows improved bit error rate (BER) performance with existing legacy transmitters.

The DFE 5 uses an unrolled non-linear cancellation method [“Techniques for High-Speed implementation of Non-linear cancellation” S. Kasturia IEEE Journal on selected areas in Communications. June 1991]. The data output (i.e. the 1s and 0s originally transmitted) is the result of a magnitude comparison between the output of the FFE 4 and a slicer-level dynamically selected from a set stored in a set 17 of pre-programmed registers. The values are determined by a control circuit (not shown in FIG. 1) from the waveforms of test patterns sent during a setup phase of operation. The magnitude comparison is performed by a magnitude comparator 18 connected to receive the output of the FFE 4 and the selected slicer-level; it outputs a 1 if the former is higher than the latter and a 0 if it is lower or equal, thereby forming the output of the DFE 5.

The slicer-level is selected from one of 2n possible options depending on the previous n bits of data history. The history of the bits produced by the magnitude comparator 18 is recorded by a shift register 19 which is connected to shift them in. The parallel output of the shift register is connected to the select input of a multiplexer 20 whose data inputs are connected to the outputs of respective ones of the set 17 of registers holding the possible slicer-levels.

Unrolled tap adaption is performed using a least mean square (LMS) method where the optimum slicing level is defined to be the average of the two possible symbol amplitudes (+/−1) when proceeded by identical history bits. (For symmetry the symbols on the channel for the bit values 1 and 0 are given the values +1 and −1).

Although 5-taps of DFE were chosen for this implementation, this parameter is easily scaleable and performance can be traded-off against power consumption and die area. In addition, the digital equalizer is testable using standard ATPG (automatic test pattern generation) and circular built-in-self-test approaches.

The chosen clock recovery approach uses a Muller-Mueller approach [“Timing recovery in Digital Synchronous Data Receivers” Mueller and Muller IEEE Transactions on Communications May 1976.] where the timing function adapts the T/H sample position to the point where the calculated pre-cursor inter-symbol interference (ISI) or h(−1) is zero, an example being given in FIG. 3. The two curves show the post-equalized response for 010 and 011 data sequences respectively. The intersection 30 at 3440 ps occurs when the sample of the second bit is independent of the third bit—that is, h(−1)=0. This position can be detected by comparing the post-equalized symbol amplitude with the theoretical amplitude h(0) and using the difference to update the CDR's phase-interpolator.

A block diagram of the transmitter is shown in FIG. 4, which is implemented using CML techniques. The data to be transmitted (received at terminal 41) is sequentially delayed by three 1 UI delay registers 42, 43 and 44 connected in series. They produce, via the four taps before and after each delay, a nibble-wide word containing the pre-cursor, cursor and two post-cursor components. In fact to ease timing closure the data is sent to the transmitter from the digital part of the circuit that supplies the data in blocks of 4 nibbles (16 bits in parallel), the blocks being sent at a rate of 3.125/s. Each nibble is a frame of four bits of the bitstream offset by one bit from the next so the nibbles overlap and represent the data redundantly. A multiplexer then selects one of the nibbles, switching between them at a rate of 12.5×109/s, and presents that in parallel to the four taps, thereby making the bitstream appear to advance along the taps.

A 4-tap FIR output waveform is obtained from simple current summing of the time-delayed contributions. This is done with differential amplifiers 45 to 48, each having its inputs connected to a respective one of the taps and having its differential output connected to a common differential output 49. Although shown as four differential amplifiers the circuit is implemented as one differential amplifier with four inputs, which minimizes return-loss. The relative amplitude of each contribution is weighted to allow the FIR coefficients to be optimized for a given circuit (e.g. a backplane) and minimize the overall residual ISI. The weights are determined empirically either for a typical example of a particular backplane or once a backplane is populated and are stored in registers 50 to 53. The weights respectively control the controllable driving current sources 54 to 57 of the differential amplifiers 45 to 48 to scale their output current accordingly. Respective pull-up resistors 58 and 59 are connected to the two terminals of the differential output 49.

A PLL is used to generate low-jitter reference clocks for the transmitter and receiver to meet standards [“OIF-CEI-02.0—Common Electrical I/O (CEI)—Electrical and Jitter Interoperability agreements for 6 G+bps and 11 G+bps I/O”. Optical Internetworking Forum, Feb 2005; “IEEE Draft 802.3 ap/Draft 3.0—Amendment: Electrical Ethernet Operation over Electrical Backplanes” IEEE July 2006.]. Most integrated circuits will have more than one receiver 1 and the PLL is shared between them with each receiver having a phase interpolator to set the phase to that of incoming data.

The PLL uses a ring oscillator to produce four clock-phases at a quarter of the line data-rate. The lower speed clocks allow power efficient clock distribution using CMOS logic levels, but need duty-cycle and quadrature correction at the point of use. The 3.125 GHz clocks are frequency doubled (XOR function) to provide the 6.25 GHz clock for the T/H & ADC. The transmitter uses the four separate 3.125 GHz phases, but they require accurate alignment to meet jitter specifications of 0.15 UI p-p R.J. and 0.15 UI p-p D.J.

The system described has been fabricated using a 65 nm CMOS process and has been shown to provide error-free operation at 12.5 Gb/s over short channels (two 11 mm package traces, 30 cm low-loss PCB and two connectors). A legacy channel with −24 dB of attenuation at 3.75 GHz supports error free operation at 7.5 Gb/s.

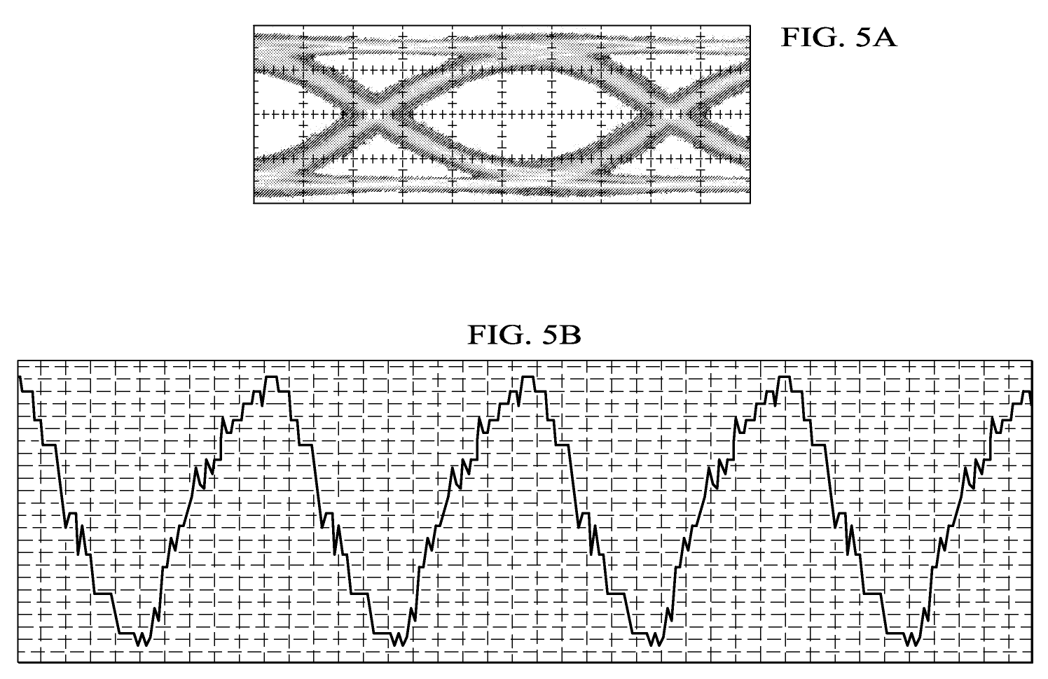

FIG. 5a shows a 12.5 Gb/s 27-1 pseudo random bit stream (PRBS) transmitted eye-pattern with 20% de-emphasis on the first post-cursor. The receiver includes, for test purposes, a PRBS data verifier 66, which confirms that the test pattern has been received. The differential peak-to-peak (pp) amplitude is 700 mV (200 mV/div). FIG. 5b shows the ADC output when a 6.25 GHz sine-wave is sampled and the phase between the sine-wave and receiver is incremented using a programmable delay-line. The measured codes are within +/−1 lsb (least significant bit) of the expected values. This level of performance ensures robust operation over a wide range of cables, green-field and legacy channels. The worst-case power of a single TX/RX pair, or “lane” is 330 mW and the total exemplary macro area is 0.45 mm 2 per lane (allowing for the PLL being shared by four TX/RX lanes.

A first example of the present invention provides a routine “connect_real”, written in the programming language C, which can be called from within Verilog modules. (The ability to call C routines is a standard feature of later versions of Verilog.) The routine connect_real is used to provide a “real” channel between modules through which numbers of type real (64-bit floating point numbers) can be passed. The “real” numbers can be used to represent analogue signals as described above, for example with a value of 1.3 corresponding to an analogue signal of 1.3V.

When a real channel is to be used in a module, a port, for example a reg or a wire, is defined for each channel in the usual way. A module might for example have an input signal IN and an output signal OUT, both declared as wires. For each channel, a variable of real data type is also declared; in the example, these would be the variables IN_real and OUT_real.

Within an “initial” block of the module, the routine real_channel is called for each real input channel to be created, in each case being passed the declared signal. (An “initial” block is run before the simulation of the circuit begins; in other words, it is used to put the module in its initial state.) In the present example, therefore, connect_real would be called once, being passed the signal IN.

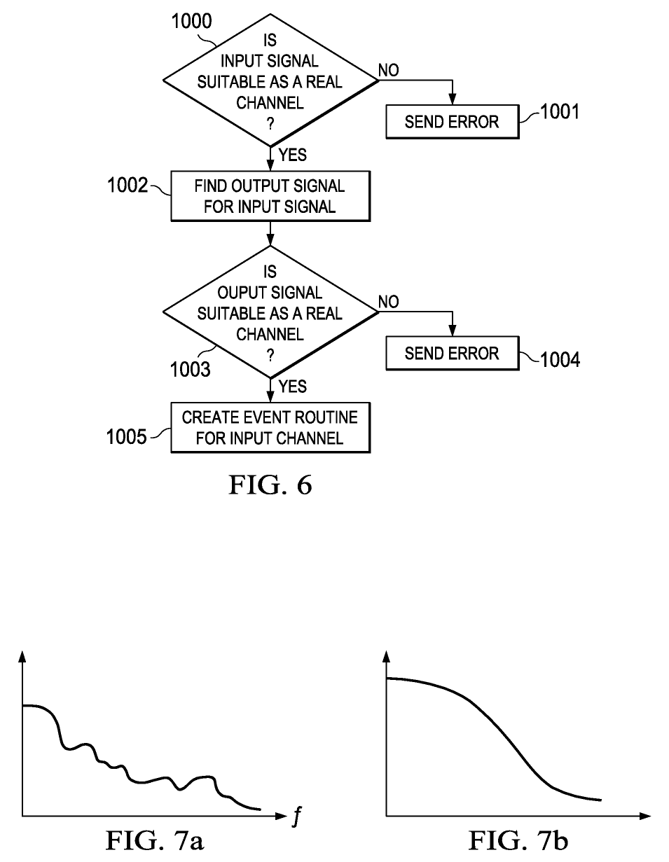

The operation of the real_channel routine on initialisation is shown in FIG. 6. First, the routine checks that the input signal it is passed is suitable for use as a real channel (step 1000), and returns an error if that is not the case (step 1001). A signal is not suitable if for example the signal is not accessible or is of the wrong data type (for example not a wire or a reg), or if there is no real variable corresponding to the input signal (for example the real variable IN real corresponding to the signal IN).

If the input signal is suitable, the routine then finds the output signal corresponding to the input signal (step 1002). For each input signal there should be an output signal, as this is where the input signal gets its input from. As part of its standard functionality, Verilog is able to check that each input signal has a corresponding output signal, and can be queried to provide details of the output signal for each input signal. The Verilog system will therefore have already ensured that such and output signal exists. (If not, it will have previously sent an error message.)

The routine then checks that output signal is suitable as a real channel (step 1003), similarly to the check for an input signal in step 1000, and again returns an error if that is not the case (step 1004).

If the output signal is suitable, the routine creates for each input channel an event routine that can be called during the simulation of the circuit (step 1005). An event routine is a piece of code that is triggered by something that happens during the simulation execution. The event code, a “value-change routine”, is triggered by a change in the real variable corresponding to the output channel connected to the input channel. (The identity of the output channel, and thus of relevant real variable, is known from step 1002.) A change in the real variable corresponding to an output channel will happen due to code in a module; for example, a module might be assign the value 1.3 to the variable OUT_real, to signify that the analogue signal in the channel is at 1.3V. When the change occurs, the event routine updates each real variable corresponding to the input channel. As the initialisation procedure of FIG. 6 provides an event routine for each input channel connected to the output channel, each input channel is updated accordingly. The code in modules can thus be written to react to changes to input channels in the same way as for the usual Verilog signals.

It can be seen that the use of the real_channel routine acts to provide channels for passing analogue signals encoded as “real” numbers between the modules, and the initialisation procedure ensures that the channels are correctly linked and updated, and enable the variables used for the channels to be created for each instance of a module, so making the module code portable.

An example of the use of the connect_real routine is as follows. A module changing_signal is as follows:

```
module changing_signal (IN, OUT);
    input IN;
    wire IN;
    real IN_real;
    output OUT;
    reg OUT;
    real OUT_real;
    initial begin
        $connect_real(IN);
        OUT_real = 0.0;
    end
    always @ (IN_real) begin
        OUT_real = IN_real * 3.0;
    end
endmodule
```

The module has input IN, which is a wire, and an output OUT, which is a reg. IN and OUT are to be used as real channels, and so there are corresponding real variables IN_real and OUT_real is declared. An initial block calls the routine connect_real, passing it the input signal IN. The routine checks that IN is suitable for a real channel (which it is), finds the output channel corresponding to IN (which will be in another module), and generates an event routine that updates IN_real whenever the real variable corresponding to the output channel in the other module is updated. The initial block then sets the real variable OUT_real to 0.0; in other words, the output channel is set at an analogue value of 0.0V.

An always block is defined to execute when the real variable IN_real changes. When that occurs, the real variable OUT_real is set to the value of IN_real times 3.0; in other words, the analogue value of output channel is the analogue value of the input channel amplified 3-fold. The event routine will ensure that IN_real is always assigned the correct value, as it will update IN_real whenever the real variable corresponding to the output to which IN is connected changes. This in turn causes the always block to be executed, updating OUT_real with 3 times the new value.

Once the modelling of analogue signals is possible in Verilog, the ability to model a transmission channel can also be added. Channels are commonly characterised in the frequency domain. An analogue simulation of the channel is made using a simulator such as SPICE, and is used to find the output of the channel in response to an impulse (a zero-second pulse) input. The output of the channel can be used to construct an impulse response table, which characterises the behaviour of the channel. The output of the channel for different inputs can be determined using the impulse response table, by combining instances of the table; each time the input to the channel changes, a new instance of the table is added to the output signal.

Such a channel model is given by a set of C routines which implements the impulse response model for a particular impulse response table. A new channel is created using a routine “channel”, which is passed the filename where the imuse response table is stored and a “real” number which gives the update rate for the output of the channel, and returns an integer which is used to identify the channel. During execution the inputs to the channel can be added using a routine “channel_add_step”, which is passed an integer identifying the channel and a real giving the input voltage. The output voltage of the channel is updated using a routine “channel_calc”, which is passed an integer identifying the channel and returns a real giving the output voltage.

A channel model is particularly useful when using Verilog to model the Serdes circuit, in particular the behaviour of the decision feedback equalisation (DFE). The DFE is used to recover an original signal input to a channel from the output of the channel; a channel in general acts as a filter taking out more of the signal at higher frequencies. The DFE has a set of coefficients it applies to the output of the channel in order to recover the original signal. Often the original signal is constructed by combining a number of copies the output of the channel delayed by respective amounts; each delayed signal is amplified by a respective coefficient.

In an ideal case, the coefficients of the DFE will correspond to the inverse of the filter applied by the channel. However, there will be some margin for error for the coefficients within which the original signal will be recovered sufficiently for the circuit to still work correctly; however, greater errors in the coefficients will make the circuit more susceptible to errors due to noise, for example. Therefore when testing the DFE, as well as checking that the circuit works correctly with a given input signal (which will be the output of a channel), it is also useful to work out the inverse of the filter of the channel, and compare this to the coefficients used by the DFE.

Most channel models are real, in other words the impulse response table is generated from the simulation of a real channel. An example characteristic for a real channel is shown in FIG. 7a, where the horizontal axis is the frequency of the signal and the vertical axis is the proportion of the signal transmitted by the channel. As can be seen, although in general the filtering increases as the frequency increases, the increase in filtering by the channel is not smooth. Because of this, it is difficult to calculate the inverse of the characteristic of the channel, and so difficult to calculate the ideal coefficient for the DFE.

However, an artificial channel characteristic that is easily inverted can be used instead of a real channel characteristic. Such an artificial channel characteristic is shown in FIG. 7b. As can be seen, the channel again acts as a filter taking out more of the signal at higher frequencies, but in this case the increase in filtering is very smooth, which means that it can easily be inverted. This allows the ideal coefficients for the DFE to be easily calculated, making the testing of the DFE easier.

What is claimed is:

1. An analogue signal modelling routine for a hardware description language, wherein an output providing an analogue signal is represented by a value stored in an output variable, an input accepting the analogue signal is represented by a value stored in an input variable, and the routine is arranged to update the value stored in the input variable when the value stored on the output value is changed.

2. An analogue signal modelling routine as claimed in claim 1, wherein the input and output variables are arranged to store floating point numbers.

3. An analogue signal modelling routine as claimed in claim 2, wherein the floating point numbers comprise 64 bits.

4. An analogue signal modelling routine as claimed in claim 1, comprising an initialisation module arranged to perform the steps of:
for each input variable representing an input accepting an analogue signal, determining the corresponding output variable;
providing an event routine for updating the value stored in the input variable when the value stored on the output value is changed.

5. An analogue signal modelling routine as claimed in claim 4, wherein each output variable has a corresponding output connection port, and each input variable has a corresponding input connection port.

6. An analogue signal modelling routine as claimed in claim 5, wherein the initialisation module determines the output variable corresponding to an input variable using the corresponding input and output connection ports.

7. A analogue signal modelling routine as claimed in claim 5, wherein the initialisation module is further arranged to perform the step of checking that for each input connection port there exists a corresponding input variable.

8. A analogue signal modelling routine as claimed in claim 7, wherein the initialisation module is further arranged to perform the step of checking that the input variable is of a suitable type.

9. A analogue signal modelling routine as claimed in claim 5, wherein the initialisation module is further arranged to perform the step of checking that for each output connection port there exists a corresponding output variable.

10. A analogue signal modelling routine as claimed in claim 8, wherein the initialisation module is further arranged to perform the step of checking that the output variable is of a suitable type.

11. A analogue signal modelling routine as claimed in claim 4, wherein a respective event routine is provided for each input variable.

12. A method of modelling an analogue signal in a hardware description language, comprising the steps of:
providing an output variable to represent an output analogue signal;
providing an input variable to represent an input analogue signal;
updating the value stored in the input variable when the value stored on the output value is changed.

13. A method as claimed in claim 12, further comprising the steps of:
for each input variable representing an input accepting an analogue signal, determining the corresponding output variable;
providing an event routine to perform the step of updating the value stored in the input variable when the value stored on the output value is changed.

14. A method as claimed in claim 13, further comprising the steps of:
providing an output connection port corresponding to the output variable;
providing an input connection port corresponding to the input variable;
wherein the step of determining for an input variable the corresponding output variable is performed using the input connection port.

15. A method as claimed in claim 13, wherein a respective event routine is provided for each input variable.

16. An analogue signal modelling routine as claimed in claim 1, further comprising a transmission channel modelling routine.

17. An analogue signal modelling routine as claimed in claim 16, wherein the transmission channel modelling routine uses an impulse response model.

18. A method of testing a circuit that takes as input an analogue signal, using a hardware description language incorporating an analogue signal modelling routine as claimed in claim 16, comprising the steps of:
providing a description of the circuit in the hardware description language;
providing an artificial channel characteristic;
using the artificial channel characteristic to generate a model of a channel;
using the model of the channel to transform an input signal;
simulating the behaviour of the circuit when input with the transformed input signal.

19. A method as claimed in claim 18, wherein the circuit to be tested comprises a decision feedback equalisation circuit.

20. A method as claimed in claim 19, further comprising the steps of:
determining the inverse of the artificial channel characteristic;
comparing the configuration of the decision feedback equalisation circuit during the simulation of the circuit with the inverse of the artificial channel characteristic.

21. A method as claimed in claim 20, wherein the artificial channel characteristic is chosen to be easily inverted.

22. A method as claimed in claim 21, wherein the artificial channel characteristic is chosen to have a feedback response that drops smoothly with increased frequency.
